(19) United States
(12) Patent Application Publication
(10) Pub. No.: US 2011/0128676 A1
(43) Pub. Date: Jun. 2, 2011

(54) PROCESS FOR PRODUCING ELECTROLYTIC CAPACITORS HAVING A LOW LEAKAGE CURRENT

(75) Inventors: Hikmet Karabulut, Duesseldorf (DE); Udo Merker, Koeln (DE); Knud Reuter, Krefeld (DE); Gerd Passing, Huerth (DE)

(73) Assignee: H.C. STARCK GMBH, Goslar (DE)

(21) Appl. No.: 12/995,467

(22) PCT Filed: May 13, 2009
(86) PCT No.: PCT/EP09/55751

§ 371 Date: Jan. 26, 2011

(30) Foreign Application Priority Data
Jun. 2, 2008 (DE) 10 2008 026 304.4

(51) Int. Cl. H01G 9/042; H01G 9/048

(52) U.S. Cl. 361/528; 29/25.03

(57) ABSTRACT

Process for producing a capacitor anode based on at least one of a valve metal and a compound having properties comparable to a valve metal includes providing a pressing or cutting tool which is at least one of made of and coated with a pressing or cutting tool material comprising at least one of a metal carbide, an oxide, a boride, a nitride, a silicide, a carbonitride or alloys thereof, a ceramic material, a hardened steel, an alloy steel, and a capacitor anode material. Particles of the at least one of a valve metal and a compound having properties comparable to a valve metal are pressed or cut with the pressing or cutting tool so as to produce a porous electrode body and form the capacitor anode.

### CROSS REFERENCE TO PRIOR APPLICATIONS

This application is a U.S National Phase application under 35 U.S.C. §371 of International Application No. PCT/EP2009/055751, filed on May 13, 2009 and which claims benefit to German Patent Application No. 10 2008 026 304.4, filed on Jun. 2, 2008. The International Application was published in English on Dec. 10, 2009 as WO 2009/147002 A2 under PCT Article 21(2).

### FIELD

The present invention provides a process for producing electrolytic capacitors having a low leakage current (also known as residual current). The present invention also provides electrolytic capacitors produced by this process and the use thereof.

### BACKGROUND

A solid-state electrolytic capacitor generally comprises a porous metal electrode, an oxide layer located on the metal surface, an electrically conductive solid which is introduced into the porous structure, an outer electrode such as a silver layer or a cathode foil and also further electrical contacts and encapsulation. The oxide layer located on the metal surface is referred to as the dielectric, with the dielectric and the porous metal electrode together forming the capacitor anode. The capacitor cathode is formed by the electrically conductive solid which is introduced into the porous structure.

Examples of solid-state electrolytic capacitors are tantalum, aluminium, niobium and niobium suboxide capacitors (electrode material of the anode) having charge transfer complexes, manganese dioxide or polymer solid-state electrolytes (electrode material of the cathode). When tantalum, niobium and niobium suboxide are used as porous electrode material, the electrode body is produced by pressing a corresponding metal powder. Here, the metal powder used can be doped with foreign atoms. After pressing, the anodes are sintered at high temperatures. In the case of aluminium capacitors, aluminium foils rather than powders are used and these are cut to size to form electrode bodies. The use of porous bodies has the advantage that a very high capacitance density, i.e., a high electrical capacitance in a small space, can be achieved because of the large surface area. The resulting solid-state electrolytic capacitors are for this reason, and also because of the weight advantage associated therewith, used in mobile electronic appliances (including for communication, navigation, mobile music, photographic and video appliances and mobile game consoles). A further advantage of capacitors made of, in particular, tantalum, niobium and niobium suboxide powders is their great reliability, which in combination with their volume efficiency has also opened up medical technology (for example, hearing aids) as a field of application.

Owing to their high electrical conductivity, π-conjugated polymers are particularly suitable as solid-state electrolytes. π-conjugated polymers are also referred to as conductive polymers or synthetic metals. These are gaining increasing economic importance since polymers have advantages over metals in respect of processability, weight and targeted setting of properties by chemical modification. Examples of known π-conjugated polymers are polypyrroles, polythiophenes, polyanilines, polyacetylenes, polyphenylenes and poly(p-phenylene-vinylenes), with a particularly important and industrially utilized polythiophene being poly-3,4-(ethylene-1,2-dioxy)thiophene, often also referred to as poly(3,4-ethylenedioxythiophene), since it has a very high conductivity and a high thermal stability in its oxidized form.

Modern solid-state electrolytic capacitors require not only a low equivalent series resistance (ESR) but also a low leakage current and good stability under external stresses. Particularly during the production process, high mechanical stresses occur during encapsulation of the capacitor anodes and these can greatly increase the leakage current of the capacitor anode.

Stability under such stresses and thus a low leakage current can be achieved, for example, by means of an about 5-50 μm thick outer layer of conductive polymers on the capacitor anode. Such a layer serves as a mechanical buffer between the capacitor anode and the cathode-side contact. This prevents, for example, the silver layer (contact) from coming into direct contact with the dielectric or damaging the latter under mechanical load and therefore increasing the leakage currents of the capacitor. The quality of the oxide layer (dielectric) is a fundamental determinant of the leakage currents occurring in capacitors. If defects are present here, electrically conductive paths are formed through the otherwise anodically current-blocking oxide layer. The conductive polymeric outer layer itself should have self-healing properties: relatively small defects in the dielectric on the outer anode surface which occur despite the buffering action are electrically insulated by virtue of the conductivity of the outer layer being destroyed by the electric current at the defect.

EP 1524678 describes a solid-state electrolytic capacitor which has a low ESR and a low leakage current and contains a polymeric outer layer containing conductive polymers, polymeric anions and a binder. A conductive polymer is used as a solid-state electrolyte and a tantalum anode is described as an anode in the examples.

WO 2007/031206 describes a solid-state electrolytic capacitor corresponding to that in EP 1524678, in which the particles of the solid-state electrolyte are formed by a conductive polymer comprising particles having an average diameter of 1-100 nm and a conductivity of greater than 10 S/cm. Polymeric solid-state electrolytes based on tantalum, niobium or niobium oxide which have a low ESR and a low leakage current are described.

In the above-mentioned solid-state electrolytic capacitors having a low leakage current, the composition of the polymeric outer layer and/or the polymeric solid-state electrolyte has an influence on the magnitude of the leakage current, i.e., the leakage current is reduced by means of the cathode of the solid-state electrolyte.

Apart from influencing the magnitude of the leakage current via the cathode side, it is also possible to influence the magnitude of the leakage current via the anode side of the solid-state electrolytic capacitor. However, it has hitherto not been possible to produce solid-state electrolytic capacitors in which, for example, conductive polymers are used as cathode material and which contain, in particular, niobium or niobium suboxide as anode material and also have a low leakage current.

A need therefore exists for new processes for producing capacitor anodes which can be used for producing solid-state electrolytic capacitors having a low leakage current. In these solid-state electrolytic capacitors, the magnitude of the leakage current is independent of whether, for example, a manganese dioxide or polymeric solid-state electrolyte is used as capacitor cathode.

### SUMMARY

An aspect of the present invention is to provide a process for producing capacitor anodes. An additional aspect of the present invention is to provide the solid-state electrolytic capacitors which can be produced therewith.

In an embodiment, the present invention provides a process for producing a capacitor anode based on at least one of a valve metal and a compound having properties comparable to a valve metal which includes providing a pressing or cutting tool which is at least one of made of and coated with a pressing or cutting tool material comprising at least one of a metal carbide, an oxide, a boride, a nitride, a silicide, a carbonitride or alloys thereof, a ceramic material, a hardened steel, an alloy steel, and a capacitor anode material. Particles of the at least one of a valve metal and a compound having properties comparable to a valve metal are pressed or cut with the pressing or cutting tool so as to produce a porous electrode body and form the capacitor anode.

### BRIEF DESCRIPTION OF THE DRAWINGS

The present invention is described in greater detail below on the basis of embodiments and of the drawings in which:

FIG. 1 shows leakage currents of anodes made of niobium suboxide powder having a capacitance of 60,000 or 80,000 μFV/g treated as set forth in Table 1 and measured by means of a two-point measurement for Examples 1-5;

FIG. 2 shows leakage currents of anodes made of niobium suboxide powder having a capacitance of 60,000 μFV/g treated as set forth in Table 2 and measured on a finished but unencapsulated capacitor by means of a two-point measurement for Examples 1 and 6; and

FIG. 3 shows leakage currents of anodes made of niobium suboxide powder having a capacitance of 60,000 μFV/g treated as set forth in Table 3 and measured by means of a two-point measurement for Examples 7a and 7b.

### DETAILED DESCRIPTION OF THE INVENTION

In an embodiment, the present invention provides a process for producing capacitor anodes based on a valve metal or a compound having properties comparable to a valve metal by pressing or cutting the valve metal particles or the particles of a compound having properties comparable to a valve metal to produce the porous electrode body, characterized in that the pressing or cutting tool is made of or coated with a metal carbide, oxide, boride, nitride or silicide, a carbonitride or alloys thereof, a ceramic material, a hardened and/or alloy steel or the capacitor anode material used in the particular case.

For the purposes of the present invention, valve metals are metals whose oxide layers do not allow current flow to an equal extent in both directions: in the case of an anodically applied voltage, the oxide layers of valve metals block the flow of current, while in the case of a cathodically applied voltage, large currents which can destroy the oxide layer occur. Valve metals include Be, Mg, Al, Ge, Si, Sn, Sb, Bi, Ti, Zr, Hf, V, Nb, Ta and W and alloys or compounds of at least one of these metals with other elements. The best-known representatives of valve metals are Al, Ta and Nb. Compounds having electrical properties comparable to a valve metal are those which have metallic conductivity and are oxidizable and whose oxide layers have the above-described properties. For example, NbO has metallic conductivity but is generally not considered to be a valve metal. However, layers of oxidized NbO display typical properties of valve metal oxide layers, so that NbO and alloys or compounds of NbO with other elements are typical examples of such compounds having electrical properties comparable to a valve metal.

Preference is given to using capacitor anodes based on aluminium, tantalum, niobium, niobium oxide or niobium suboxide.

When the capacitor anode is based on niobium, niobium oxide or niobium suboxide, it can, for example, comprise niobium, NbO, niobium suboxide NbOₓ, where x can be from 0.8 to 1.2, niobium nitride, niobium oxynitride or mixtures of these materials or an alloy or compound of at least one of these materials with other elements. If the capacitor anode is based on tantalum, it can, for example, comprise tantalum, tantalum nitride or tantalum oxynitride.

In an embodiment of the present invention, alloys can be used which contain, for example, at least one valve metal such as Be, Mg, Al, Ge, Si, Sn, Sb, Bi, Ti, Zr, Hf, V, Nb, Ta and W. Accordingly, the term “oxidizable metal” encompasses not only metals but also alloys or compounds of a metal with other elements, as long as they have metallic conductivity or are oxidizable.

The pressing or cutting tools used for the process of the present invention can be made of metal carbides, oxides, borides, nitrides or silicides. Suitable metal carbides, oxides, borides, nitrides or silicides are those of the metals tungsten, titanium, molybdenum, tantalum, niobium, chromium or vanadium. Alloys of the abovementioned metals are also suitable for producing the pressing or cutting tools.

The pressing or cutting tools can, for the purposes of the present invention, also be made of ceramic materials based on oxides such as aluminium titanate, zirconium oxide-reinforced aluminium oxide or other dispersion ceramics, aluminium oxide, magnesium oxide, zirconium oxide or titanium dioxide, nitrides such as boron nitride, silicon nitride or aluminium nitride, or carbides such as silicon carbide or boron carbide. However, these pressing or cutting tools can also be based on borides, silicides or composite ceramics.

The abovementioned materials of which the pressing or cutting tools are made are defined as low-wear, for example, their concentration on the surface of the pressed or cut capacitor anode is only 300 ppm higher, for example, 100 ppm higher, for example, 50 ppm higher, for example, 10 ppm higher, or 1 ppm higher, than in the powder used.

For the purposes of the present invention, the capacitor anode can be produced as follows: firstly, a valve metal powder is, for example, pressed with the aid of the abovementioned pressing tool to a pressed density of from 1.5 to 5 gcm⁻³ (powders based on niobium) or from 3.5 to 9 gcm⁻³ (powders based on tantalum) to form green bodies, with the pressed density selected depending on the powder used. The green bodies are subsequently sintered at a temperature of >1000° C. The electrode body obtained in this way is then, for example, coated with a dielectric, for example, an oxide layer, by electrochemical oxidation (activation). Here, the porous electrode bodies are, for example, oxidized using a suitable electrolyte, such as phosphoric acid, by application of a voltage. The magnitude of this activation voltage depends on the oxide layer thickness to be achieved or the future use voltage of the capacitor. Activation voltages can, for example, be from 1 to 300 V, for example from 1 to 80 V. These porous electrode bodies have an average pore diameter of from 10 to 10 000 nm, for example, from 50 to 5000 nm, or from 100 to 3000 nm.

The anode bodies can be defined according to the following formula:

(capacitance [C]×activation voltage [V])/weight of the electrode body [g]

A cutting tool is used instead of the pressing tool when the capacitor anode comprises, for example, aluminium. When a cutting tool is used, the capacitor anode is produced as follows: the aluminium foil used is, for example, coated with a dielectric, for example, an oxide layer, by electrochemical oxidation. The foil is subsequently cut into strips. Two of these strips are firstly connected to a contact wire and then rolled up with a paper or textile strip as a separation layer to form an anode body. The two aluminium strips here represent anode and cathode of the capacitor, while the intermediate strips function as spacers. A further possible way of manufacturing aluminium capacitors is to coat aluminium strips which have been cut to size with a dielectric, such as an oxide layer, for example by electrochemical oxidation, and then join these together in a stack to form a capacitor body. Here too, the contacts are brought to the outside.

Furthermore, it has surprisingly been found that the leakage current of capacitor anodes can likewise be reduced significantly by treating the capacitor anodes with a complexing agent, an oxidant, a Brønsted base or a Brønsted acid (dipping process) immediately after pressing or cutting or after sintering or else only after the oxide layer has been applied. Here, the dipping process for the capacitor anodes can be carried out after each of the three process steps, i.e., after pressing or cutting, after sintering or after activation, or the dipping process is carried out only in the case of two of these process steps or only after one of these process steps.

The present invention thus further provides a process for producing capacitor anodes based on a valve metal or a compound having properties comparable to a valve metal, characterized in that the porous anode body is treated with a compound selected from the group consisting of complexing agents, oxidants, Brønsted bases and Brønsted acids.

Suitable complexing agents are, for example, substances based on oxalic acid, acetic acid, citric acid, succinic acid or amines. Owing to their complexing ability, use is usually made of a substance such as EDTA (ethylenediaminetetraacetic acid), DTPA (diethylenetriaminepentaacetic acid), HEDTA (hydroxyethylethylenediaminetriacetic acid), NTA (nitrilotriacetic acid), EDTA-Na_{z} (ethylenediaminetetraacetic acid disodium salt), CDTA (cyclohexanediamine-(1,2)-tetraacetic acid), EGTA (ethyleneglycol-bis(aminoethyl ether)-N,N′-tetraacetic acid), TTHA (triethylenetetraminehexaacetic acid) or DTA (diaminetetraacetic acid), which combines a plurality of complexing functions in one molecule.

Oxidants which are suitable for the purposes of the present invention are fluorine, chlorine, bromine, iodine, oxygen, ozone, hydrogen peroxide (H₂O₂), oxygen difluoride, sodium percarbonate, oxygen-containing anions of transition metals (such as, for example, permanganate MnO₄⁻ or dichromate Cr₂O₇²⁻), anions of halogen oxo acids such as bromate BrO₃⁻, metal ions such as Ce⁴⁺ or noble metal ions (for example, of silver or copper).

The term Brønsted acids refers to compounds which act as proton donors and the term Brønsted bases refers to compounds which act as proton acceptors. Examples of Brønsted bases are the hydroxides of the alkali and alkaline earth metals, for example, sodium hydroxide and calcium hydroxide, and solutions of ammonia in water, and examples of Brønsted acids are hydrofluoric acid (HF), hydrochloric acid (HCl), nitric acid (NHO₃), sulphuric acid (H₂SO₄), phosphoric acid (H₃PO₄), carbonic acid (H₂CO₃) and also organic acids such as acetic acid.

For the purposes of the present invention, the complexing agent, the oxidant, the Brønsted base or the Brønsted acid is present in liquid or solution form. The oxidant can also be present in gaseous form, i.e., ozone or fluorine, for example, can be used as gaseous oxidant. If a gaseous oxidant is used, it is possible to use the pure gas, a gas diluted with, for example, nitrogen or a mixture of two different gaseous oxidants. It is also possible to use mixtures of at least two different complexing agents, at least two different oxidants, at least two different Brønsted bases or at least two different Brønsted acids.

The concentration of complexing agent, oxidant, Brønsted base or Brønsted acid can, for example, be in the range from 0.001 M to 10 M, for example, in the range from 0.01 M to 8 M, for example, in the range from 0.1 M to 5 M or from 0.5 M to 2 M.

It has also surprisingly been found that the leakage current of capacitor anodes can also be reduced significantly by treating the capacitor anodes with an organic tantalum compound present as a liquid or in solution (dipping process) after they have been pressed and sintered and after the oxide layer has been applied.

The present invention therefore provides a process for producing capacitor anodes based on a valve metal or a compound having properties comparable to a valve metal, characterized in that the activated anode body is treated with an organic tantalum compound present as a liquid or in solution.

In an embodiment of the present invention, the water content of the liquid organic tantalum compound or its solution can be as low as possible, for example, the water content can be less than 1% by weight, such as less than 0.5% by weight, or less than 0.1% by weight.

The concentration of the organic tantalum compound which is in liquid form when used can, when it is present in solution, be in the concentration range from 0.001 M to 10 M, for example, in the range from 0.01 M to 6 M, or in the range from 0.1 M to 3 M, or the pure organic tantalum compound can also be used when it is present in liquid form.

In an embodiment of the present invention, only the outermost region of the capacitor anode comes into contact with the organic tantalum compound during the dipping process, since, surprisingly, only a little of the total capacitance is lost in this procedure. This can be achieved by filling the porous structure of the electrode body with a protic liquid (for example, water) or aprotic liquid (for example, acetonitrile) before treatment with the organic tantalum compound. As organic tantalum compound, it is possible to use, for example, tantalum alkoxides such as tantalum ethoxide, tantalum amides or tantalum oxalate.

The present invention also provides the capacitor anodes produced by the process of the present invention. The capacitor anodes of the present invention are suitable for producing solid-state electrolytic capacitors having a low leakage current. These inventive solid-state electrolytic capacitors can be used as components in electronic circuits, for example, as filter capacitor or decoupling capacitor. The present invention therefore additionally provides these electronic circuits. Preference is given to electronic circuits which are present, for example, in computers (desktops, laptops, servers), in computer peripherals (such as PC cards), in portable electronic appliances, such as mobile telephones, digital cameras or entertainment electronics, in appliances for entertainment electronics, such as in CD/DVD players and computer game consoles, in navigation systems, in telecommunications facilities, in household appliances, in power supplies or in automobile electronics.

The following examples serve to illustrate the present invention by way of example and are not to be interpreted as a restriction.

### EXAMPLES

### Examples 1-5

Anodes made of niobium suboxide powder and having a capacitance of 60 000 or 80 000 μFV/g (=NbO 60K or 80K) were activated at 35 V in phosphoric acid. The activation electrolyte was subsequently washed from the anodes in water having a temperature of 85° C. for one hour and the anodes were then dried at 85° C. in an oven for one hour. Some of the oxidized anode bodies produced in this way were then introduced into a dipping bath containing NaOH, H₂O₂, oxalic acid or HF, i.e., treatment of the oxidized anode body with these compounds was carried out. The duration of the dipping process was 30 or 60 seconds (sec.). After the treatment, the anodes were once again rinsed in water and then again dried at 85° C. The anode bodies obtained in this way were then provided with a solid-state electrolyte (=polymeric solid-state electrolyte) by means of a chemical in-situ polymerization. For this purpose, a solution comprising one part by weight of 3,4-ethylenedioxythiophene (Clevios™ M, H.C. Starck GmbH) and 20 parts by weight of a 40% strength by weight ethanolic solution of iron(III) p-toluenesulphonate (Clevios™ C-ER, H.C. Starck GmbH) was prepared.

The solution was used for impregnating the anode bodies. The anode bodies were steeped in this solution and subsequently dried at room temperature (20° C.) for 30 minutes. They were then heat treated at 50° C. in a drying oven for 30 minutes. The anode bodies were subsequently washed in a 2% strength by weight aqueous solution of p-toluenesulphonic acid for one hour. The electrode bodies were then reactivated in a 0.25% strength by weight aqueous solution of p-toluene-sulphonic acid for 30 minutes, subsequently rinsed in distilled water and dried. A total of three double impregnations were carried out in this procedure. The anode bodies were subsequently coated with graphite and silver.

Other oxidized anode bodies were, without further treatment, directly impregnated with the cathode material as described in the above process and subsequently coated with graphite and silver.

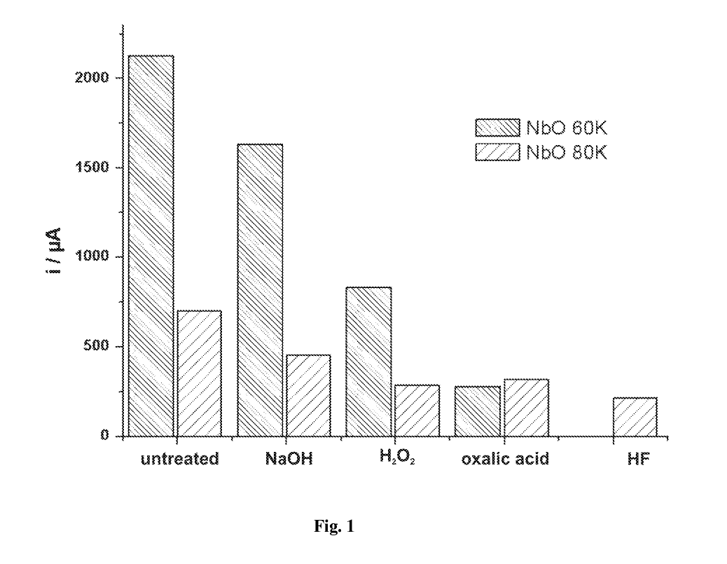

The leakage currents were measured on the now finished but unencapsulated capacitor by means of a two-point measurement. Here, the leakage current was determined by means of a Keithley 199 multimeter three minutes after application of a voltage of 12 V. The results of the measurements of the leakage currents are shown in Table 1 and also in FIG. 1.

TABLE 1

| | Treatment of | Duration of | NbO 60K | NbO 80K |
|---|---|---|---|---|
| | the oxidized | the dipping | leakage | leakage |
| | anode body | process | current | current |
| | with | [sec.] | [μm] | [μm] |
| Example 1 | — | 0 | 2130 | 702 |
| Example 2 | 1M NaOH | 60 | 1632 | 454 |
| Example 3 | 35% H₂O₂ | 60 | 831 | 285 |
| Example 4 | 1M oxalic acid | 60 | 277 | 318 |
| Example 5 | 40% HF | 30 | — | 213 |

Examples 2-5 are examples according to the present invention.

### Example 6

### Example According to the Present Invention

Oxidized anode bodies (NbO 60 K) were produced by a method analogous to the process described under Examples 1-5. Some of the oxidized anode bodies produced in this way were then treated in succession as follows, i.e., a treatment of these anode bodies with the following compounds was carried out:

1. Dipping in ethanol
2. Dipping in a solution (30% of tantalum ethoxide in ethanol)

### 3. Hydrolysis in air

After the treatment, the anodes were once again rinsed in water and then again dried at 85° C. The anode bodies obtained in this way were then provided with a solid-state electrolyte (=polymeric solid-state electrolyte) by means of a chemical in-situ polymerization. For this purpose, a solution comprising one part by weight of 3,4-ethylenedioxythiophene (Clevios™ M, H.C. Starck GmbH) and 20 parts by weight of a 40% strength by weight ethanolic solution of iron(III) p-toluenesulphonate (Clevios™ C-ER, H.C. Starck GmbH) was prepared.

The solution was used for impregnating the anode bodies. The anode bodies were steeped in this solution and subsequently dried at room temperature (20° C.) for 30 minutes. They were then heat treated at 50° C. in a drying oven for 30 minutes. The anode bodies were subsequently washed in a 2% strength by weight aqueous solution of p-toluenesulphonic acid for one hour. The electrode bodies were then reactivated in a 0.25% strength by weight aqueous solution of p-toluenesulphonic acid for 30 minutes, subsequently rinsed in distilled water and dried. A total of three double impregnations were carried out in this procedure. The anode bodies were subsequently coated with graphite and silver.

Other oxidized anode bodies were, without further treatment, directly impregnated with the cathode material as described in the above process and subsequently coated with graphite and silver.

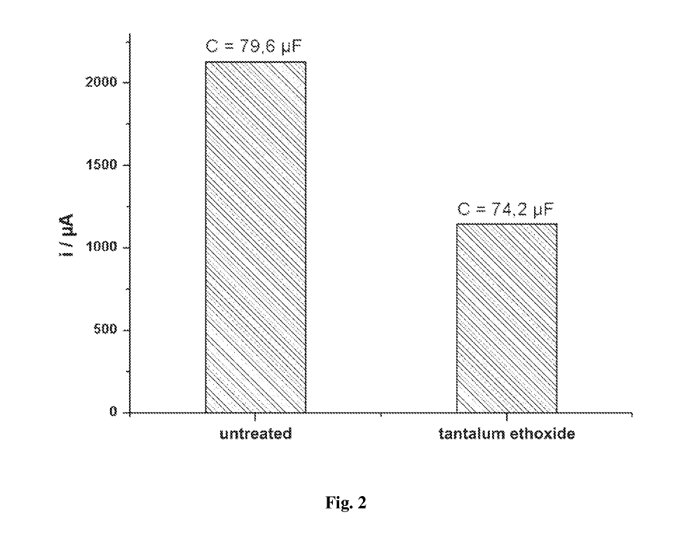

The leakage currents were measured on the now finished but unencapsulated capacitor by means of a two-point measurement. Here, the leakage current was determined by means of a Keithley 199 multimeter three minutes after application of a voltage of 12 V. The capacitance was determined at 120 Hz and a bias voltage of 10 V by means of an LCR meter (Agilent 4284A). The results of these measurements are shown in Table 2 and also in FIG. 2.

TABLE 2

| | Treatment of | Duration of the | Leakage | Capaci- |
|---|---|---|---|---|
| | the oxidized | treatment process | current | tance |
| | anode body with | [sec.] | [μA] | [μF] |
| Example 1 | — | 0 | 2130 | 79.6 |
| Example 6 | ethanol | 5-30 | 1145 | 74.2 |
| | 30% of tantalum | 5-30 | | |
| | ethoxide in ethanol | | | |
| | hydrolysis in air | at least 10 | | |

### Example 7

Niobium suboxide powder having a capacity 60 000 μFV/g (=NbO 60K) was pressed to green bodies (pressed anodes) with two different pressing tools. One pressing tool was a conventional steel pressing tool (Examples 7a), the other pressing tool was a hard metal tool made of tungsten carbide with 8.5 weight percent of cobalt binder (Example 7b). After pressing the pressed anodes were sintered to yield sintered anodes, which in turn have been anodized at 35 V in phosphoric acid. Afterwards, the sintered and anodized anodes were rinsed with water at a temperature of 85° C. to remove the phosphoric acid and dried at a temperature of 85° C. in a furnace. The anode bodies obtained in this way were then provided with a solid-state electrolyte (=polymeric solid-state electrolyte) by means of a chemical in-situ polymerization.

For this purpose, a solution comprising one part by weight of 3,4-ethylenedioxythiophene (Clevios™ M, H.C. Starck GmbH) and 20 parts by weight of a 40% strength by weight ethanolic solution of iron(III) p-toluenesulphonate (Clevios™ C-ER, H.C. Starck GmbH) was prepared.

The solution was used for impregnating the anode bodies. The anode bodies were steeped in this solution and subsequently dried at room temperature (20° C.) for 30 minutes. They were then heat treated at 50° C. in a drying oven for 30 minutes.

The anode bodies were subsequently washed in a 2% strength by weight aqueous solution of p-toluenesulphonic acid for one hour. The electrode bodies were then reactivated in a 0.25% strength by weight aqueous solution of p-toluenesulphonic acid for 30 minutes, subsequently rinsed in distilled water and dried. A total of three double impregnations were carried out in this procedure. The anode bodies were subsequently coated with graphite and silver.

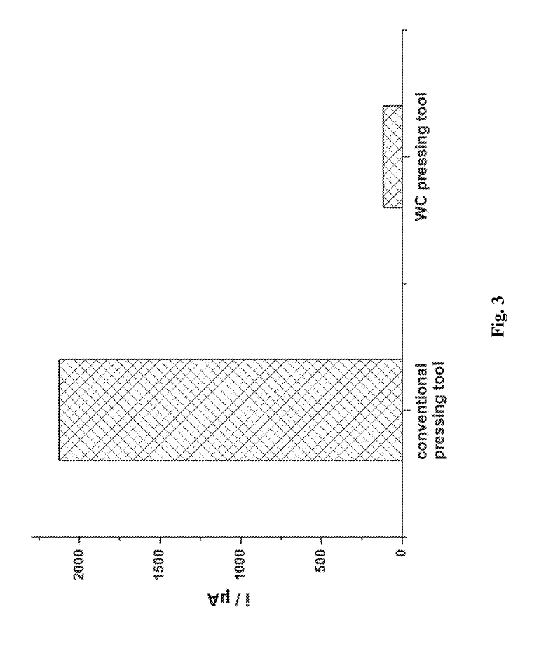

The leakage currents were measured on the now finished but unencapsulated capacitor by means of a two-point measurement. Here, the leakage current was determined by means of a Keithley 199 multimeter three minutes after application of a voltage of 12 V. The results of these measurements are shown in Table 3 and also in FIG. 3.

TABLE 3

| | Pressing tool | Leakage current [μA] |
|---|---|---|
| Example 7a | Steel | 2130 |
| Example 7b | Hard metal | 120 |
| | (WC + 8.5 wt. % Co) | |

The present invention is not limited to embodiments described herein; reference should be had to the appended claims.

1-11. (canceled)

12. Process for producing a capacitor anode based on at least one of a valve metal and a compound having properties comparable to a valve metal, the process comprising:
providing a pressing or cutting tool which is at least one of made of and coated with a pressing or cutting tool material comprising at least one of a metal carbide, an oxide, a boride, a nitride, a silicide, a carbonitride or alloys thereof, a ceramic material, a hardened steel, an alloy steel, and a capacitor anode material; and
pressing or cutting particles of the at least one of a valve metal and a compound having properties comparable to a valve metal with the pressing or cutting tool so as to produce a porous electrode body and form the capacitor anode.

13. Process as recited in claim 12, wherein a content of the pressing or cutting tool material or a material with which it is coated is less than 300 ppm on the surface of the porous electrode body after the pressing or cutting.

14. Process as recited in claim 12, wherein the at least one of a valve metal or a compound having properties comparable to a valve metal is at least one of tantalum, niobium and niobium suboxide.

15. Process for producing a capacitor anode based on at least one of a valve metal or a compound having properties comparable to a valve metal, the process comprising:
treating a porous electrode body with a compound selected from the group consisting of a complexing agent(s), an oxidant(s), a Brønsted base(s) and a Brønsted acid(s) so as to form the capacitor anode;
or
treating an activated anode body with an organic tantalum compound, wherein the organic tantalum compound is provided as a liquid or in a solution.

16. Process as recited in claim 15, wherein the complexing agent(s), the oxidant(s), the Brønsted base(s) and the Brønsted acid(s) have a concentration in the range of from 0.001 M to 10 M.

17. Process as recited in claim 15, wherein the at least one of a valve metal or a compound having properties comparable to a valve metal is at least one of tantalum, niobium and niobium suboxide.

18. Process as recited in claim 15, wherein the organic tantalum compound provided as a liquid or in a solution has a concentration in the range of from 0.001 M to 10.0 M.

19. Capacitor anode based on at least one of a valve metal and a compound having properties comparable to a valve metal, produced by the process comprising:
providing a pressing or cutting tool which is at least one of made of and coated with a pressing or cutting tool material comprising at least one of a metal carbide, an oxide, a boride, a nitride, a silicide, a carbonitride or alloys thereof, a ceramic material, a hardened steel, an alloy steel, and a capacitor anode material, and
pressing or cutting particles of the at least one of a valve metal and a compound having properties comparable to a valve metal with the pressing or cutting tool so as to produce a porous electrode body and form the capacitor anode,
or
treating a porous electrode body with a compound selected from the group consisting of a complexing agent(s), an oxidant(s), a Brønsted base(s) and a Brønsted acid(s) so as to form the capacitor anode,
or
treating an activated anode body with an organic tantalum compound, wherein the organic tantalum compound is provided as a liquid or in a solution.

20. Solid-state electrolytic capacitor containing a capacitor anode as recited in claim 19.

21. Electronic circuit containing a capacitor anode as recited in claim 19.

22. Method of using a solid-state electrolytic capacitor in an electronic circuit, the method comprising:
providing a solid-state electrolytic capacitor containing a capacitor anode with at least one of a valve metal and a compound having properties comparable to a valve metal, the capacitor anode being produced by the process comprising:
providing a pressing or cutting tool which is at least one of made of and coated with a pressing or cutting tool material comprising at least one of a metal carbide, an oxide, a boride, a nitride, a silicide, a carbonitride or alloys thereof, a ceramic material, a hardened steel, an alloy steel, and a capacitor anode material, and
pressing or cutting particles of the at least one of a valve metal and a compound having properties comparable to a valve metal with the pressing or cutting tool so as to produce a porous electrode body and form the capacitor anode,
or
treating a porous electrode body with a compound selected from the group consisting of a complexing agent(s), an oxidant(s), a Brønsted base(s) and a Brønsted acid(s) so as to form the capacitor anode,
or
treating an activated anode body with an organic tantalum compound, wherein the organic tantalum compound is provided as a liquid or in a solution; and
incorporating the solid-state electrolytic capacitor in an electronic circuit.
